(19) United States
(12) Patent Application Publication
(10) Pub. No.: US 2009/0287566 A1
(43) Pub. Date: Nov. 19, 2009

(54) USER EXPERIENCE OF ADVERTISEMENTS BY ALLOWING USERS TO IDENTIFY ADVERTISEMENTS THAT USERS DISLIKE

(76) Inventor: Randolph Preston McAfee, Sata Mario, CA (US)

Correspondence Address: MPG, LLP AND YAHOO! INC., 710 LAKEWAY DRIVE, SUITE 200, SUNNYVALE, CA, 94085, US

(21) Appl. No.: 12/121,659

(22) Filed: May 15, 2008

(51) Int. Cl. G06Q 30/00

(52) U.S. Cl. 705/14.41

(57) ABSTRACT

The embodiments of the present invention fill the need of avoiding the display of advertisements that are strongly disliked by users. Displaying advertisements that are strongly disliked (or offend), web sites stand the chance of driving users away or losing users. By allowing users to identify advertisements that offend or annoy (or are strongly disliked by them), web sites can configure the systems so that offensive or annoying advertisements are not displayed to the users in the future. In addition, when a user is seriously turned off by an advertisement, the user is more likely to indicate his/her dislike toward the advertisement (ad). The user is also likely to give a reason as to why he/she does not like the ad, and could be willing to provide further information on what types of ads are also liked or disliked by the user. User input can then be collected, enabling custom application of the user's preference for certain types of advertisements.

### BACKGROUND OF THE INVENTION

1. Field of the Invention

This invention relates generally to displaying of advertisements to Internet users, and more particularly, not displaying advertisements strongly disliked by Internet users.

2. Description of the Related Art

On-line advertising is used by advertisers to accomplish various business goals, ranging from building brand awareness among potential customers to facilitating on-line purchases of products or services. A number of different types of page-based or video-based online advertisements are currently in use, along with various associated distribution requirements, advertising metrics, and pricing mechanisms. As is well known, technologies such as Hypertext Markup Language (HTML) and Hypertext Transfer Protocol (HTTP) enable formatting to define location and presentation of selected advertisements.

An example of on-line advertisements is banner advertisement (or ad). A banner advertisement typically features an image (animated or static) and/or text displayed at a predetermined position in a page. The banner advertisement usually takes the form of a horizontal rectangle at the top of the page, but it can also be arranged in a variety of other shapes and other locations on the page. If a user clicks on the banner advertisement's location, image, and/or text, the user is taken to a new page (a landing page) that may provide detailed information regarding the products or services associated with the banner advertisement. Banner advertisement space is sold in a number of ways. Exemplary ways include a guaranteed number of impressions, performance-based, etc. Other types of on-line advertisements, such as pop-up ads, text ads, and video ads, are also commonly used. Pop-up ads appear in new web browser windows when a user accesses a new web page. Text ads appear alongside search results and are related to the search word(s) entered by the user. Video ads play videos when users open new web pages or when users click on the video ads.

Some on-line advertisements are offensive or annoying to Internet users. Some on-line advertisements take users to landing pages that have nothing to do with advertisements described earlier. For example, a user clicks on an advertisement (or ad) that is described as being related to “insurance,” but the landing page displays a pornographic page or gambling site. When these types of advertisements are displayed to Internet users, they create a bad user experience. Additionally, users can feel very uncomfortable with certain ads. As a consequence, users feel less trusting about the sites that offer these types of advertisements. If a site continues to offer ads that are strongly disliked by users, users might decide to leave the site for good, or might feel less willing to visit the site in the future.

It is in this context that embodiments of the present invention arise.

### SUMMARY OF THE INVENTION

Broadly speaking, the present invention fills the need of avoiding the display of advertisements that are strongly disliked by users. Displaying advertisements that are strongly disliked (or offend), web sites stand the chance of driving users away or losing users. By allowing users to identify advertisements that offend or annoy (or are strongly disliked by them), web sites can configure the systems so that offensive or annoying advertisements are not displayed to the users in the future. In addition, when a user is seriously turned off by an advertisement, the user is more likely to indicate his/her dislike toward the advertisement (ad). The user is also likely to give a reason as to why he/she does not like the ad, and could be willing to provide further information on what types of ads are also liked or disliked by the user. User input can then be collected, enabling custom application of the user's preference for certain types of advertisements.

It should be appreciated that the present invention can be implemented in numerous ways, including as a method, a system, or a device. Several inventive embodiments of the present invention are described below.

In one embodiment, a method of removing an advertisement disliked by a user from a web page of a web site is provided. The method includes receiving a request from the user to open the web page of the web site, and displaying an advertisement in the web page opened for the user based on the request. The method also includes receiving an input from the user indicating a dislike of the advertisement that was displayed. The method further includes removing the advertisement that was displayed and disliked by the user.

In another embodiment, a method of recording inputs of users on advertisements to prevent displaying advertisements that are known to be disliked by the users is provided. The method includes displaying an advertisement in a web page opened for the user based on a request from the user. The method also includes receiving an input from the user indicating a preference of the advertisement displayed. The input from the user is saved in at least one database. The method further includes displaying a plurality of advertisements in another web page for the user to indicate preferences of the user on the plurality of advertisements displayed in the other web page to gain insight of preferences of advertisements of the user. In addition, the method includes receiving inputs from the user indicating the preference of the user on the plurality of advertisements displayed on the other web page. The inputs are saved in the at least one database. Additionally, the method includes analyzing the at least one database containing the inputs from the user to select advertisements to display to the user. The inputs indicate the preferences of advertisements of the user. The analysis of the at least one database prevents displaying advertisements that are known to be disliked by the user. The method also includes displaying the advertisements that are selected to the user.

In another embodiment, a system for recording inputs of users on advertisements to prevent displaying advertisements that are disliked by the users is provided. The system includes an advertisement server storing advertisements to be displayed in web pages. The system also includes a user profile server storing information of the users. The system further includes an advertisement-preference server storing information regarding the user preference for advertisements. The information includes user identifications with advertisements that are disliked by the corresponding user identifications. The advertisement-preference server is integrated with the user profile server and the advertisement server to prevent displaying advertisements that are disliked by the users.

In yet another embodiment, computer readable media including program instructions for recording inputs of users on advertisements to prevent displaying advertisements that are known to be disliked by the users are provided. The computer readable media include program instructions for displaying an advertisement in a web page opened for the user based on a request from the user. The computer readable media also include program instructions for receiving an input from the user indicating a preference of the advertisement displayed. The input from the user is saved in at least one database. The computer readable media further include program instructions for displaying a plurality of advertisements in another web page for the user to indicate preferences of the user on the plurality of advertisements displayed in the other web page to gain insight of preferences of advertisements of the user. In addition, the computer readable media include program instructions for receiving inputs from the user indicating the preference of the user on the plurality of advertisements displayed on the other web page. The inputs are saved in the at least one database. Additionally, the computer readable media include program instructions for analyzing the at least one database containing the inputs from the user. The inputs indicate the preferences of advertisements of the user, to select advertisements to display to the user. The analysis of the at least one database prevents displaying advertisements that are known to be disliked by the user. The computer readable media also includes program instructions for displaying the advertisements that are selected to the user.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1A shows a web browser window (or web page) of a user, in accordance with one embodiment of the present invention.

FIG. 1B shows a landing page of an ad, in accordance with one embodiment of the present invention.

FIG. 1C shows a different ad being placed in the browser window of FIG. 1B, in accordance with one embodiment of the present invention.

FIG. 1D shows a browser window (or web page) with an ad, in accordance with one embodiment of the present invention.

FIG. 1E shows a browser window that appears after User-1 clicks on the “Hate this Ad!” button, in accordance with one embodiment of the present invention.

FIG. 1F shows a browser window that appears after User-1 clicks on the “Help Us Identify What Types of Ads bother you” button, in accordance with one embodiment of the present invention.

FIG. 2A shows a system for collecting information on ads disliked by users, in accordance with one embodiment of the present invention.

FIG. 2B shows a table stored in the user ad-preference server, in accordance with one embodiment of the present invention.

FIG. 2C shows another table in the user ad-preference server, in accordance with one embodiment of the present invention.

FIG. 2D shows the components in the user ad-preference server, in accordance with one embodiment of the present invention,

FIG. 3A shows a process flow of removing an ad strongly disliked by a user, in accordance with one embodiment of the present invention.

FIG. 3B shows a process flow of removing an ad strongly disliked by a user, in accordance with another embodiment of the present invention.

### DETAILED DESCRIPTION

As described above, some on-line advertisements are offensive or annoying to Internet users. Advertisements (Ads) that take users to landing pages that have nothing to do with advertisements described in the Ad titles can seriously annoy users. As described in the example above, a user will be displeased when a user clicks on an advertisement for “insurance,” and the user is taken to a landing page having pornography, gambling, or some other topic. When misleading advertisements are displayed to Internet users, the user experience is tarnished. In fact, some users could feel very uncomfortable with certain ads, which lead to less trust in the originating site. Sometimes, users may leave the sites that offer such ads immediately upon viewing such ads or feel less willing to visit the sites in the future. Non-misleading ads can also annoy or offend users. For example, some ads have jumpy images, which are designed to attract users' attention, but in sum are very annoying to many users.

On-line users are very valuable to web sites. As a general rule, commercial web sites prefer to have as many users visiting their sites as possible, especially portals, social-networking web sites, and web sites dealing with on-line business. These web sites would also like to keep users on their sites for as long as possible, and hope that they will return often. In practicality, web sites want to display many advertisements to users, but they also do not want advertisements that create a bad user experience. Requests for displaying advertisements come from different advertisers, although some advertisers may offer web sites that are of poor quality or poor taste. For this reason, some advertisers must qualify their ads with a web site to confirm an acceptable landing page. After qualification, a bad advertiser may switch to other unacceptable (or undesirable) landing pages after being qualified. For example, a pornographic site might get qualified by a portal, such as Yahoo!, by an acceptable title, link, and a clean landing page. But, once being qualified by the portal, such as Yahoo!, an unacceptable landing page is shown to users when users click on the link of the advertisement on the portal. When this happens, users of the portal, such as Yahoo!, might become very angry at the portal or become less trusting of the portal, which is not desirable to the portal. Web sites, including the portal, want to keep the users happy so they continue using the site, not angry, risking the possibility of turning away future visitors.

In some instances, displaying undesirable ads to users is done un-intentionally. Some web sites display ads to users based on user profiles that the web sites collect, through user inputs, or clicking patterns. However, user profiles do not catch all details and web sites might display advertisements, which are considered offensive to some users, un-intentionally. For example, someone very religious that considers alcohol as a “forbidden” beverage, could see an ad of alcohol as being offensive. The web site that displays such an ad to the such a user might have collected some user profile of the user, but the profile is not detailed enough to include the user's strong dislike of alcohol or ads related to alcohol.

When users encounter ads that they strongly dislike, currently users can only close the browser windows having such ads. At best, users can send an email to the web site administrator(s) to complain about the poor user experience related to seeing ads that they strongly dislike (or hate). However, user complaints might not result in any action taken by the web site. In addition, even if the web site administrator(s) relay such information to the group in charge of on-line advertisements, the linkage (or correlation) between the users who complain about the ads and the ads, is lost. The web site could use such input to weed out misleading ads, but the web site would not be able to stop displaying ads that are offensive based on the users' taste (e.g. the alcohol ad to the religious person described above). It would be desirable to have a method and a system that allow users to identify ads that they dislike (or hate), to allow the ad-providing system to stop showing such ads.

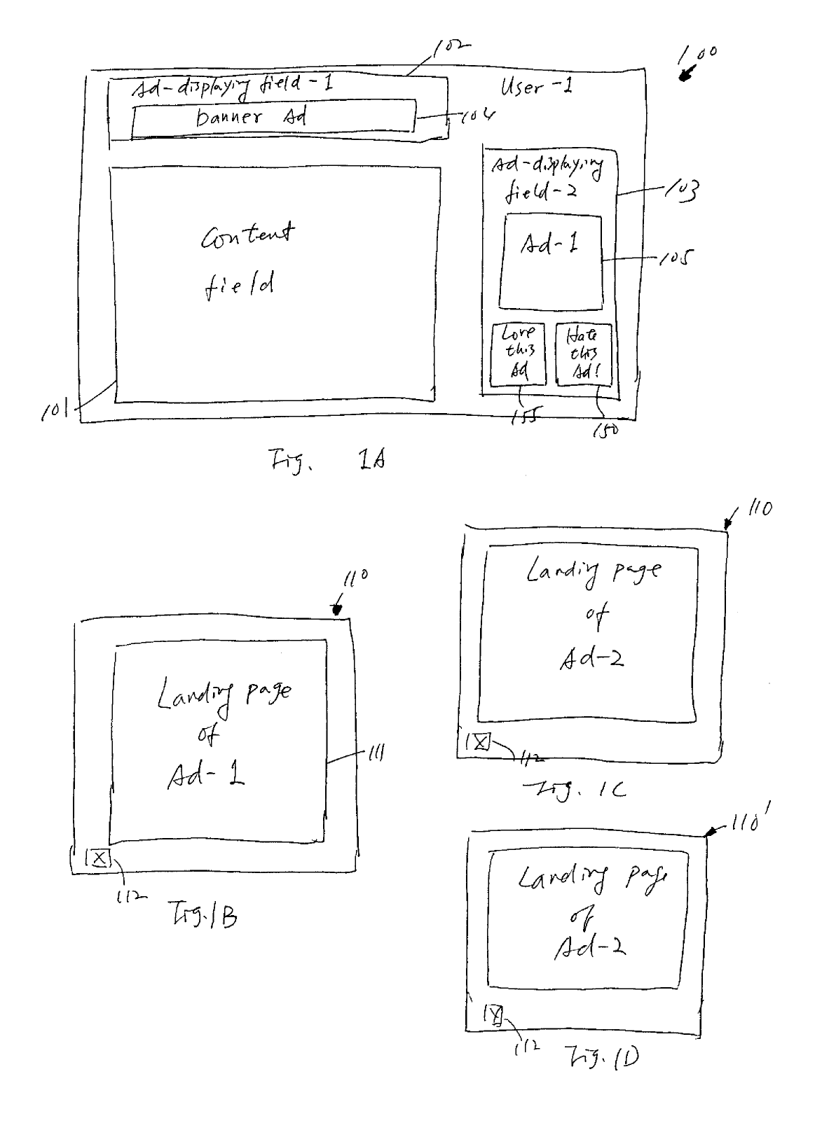

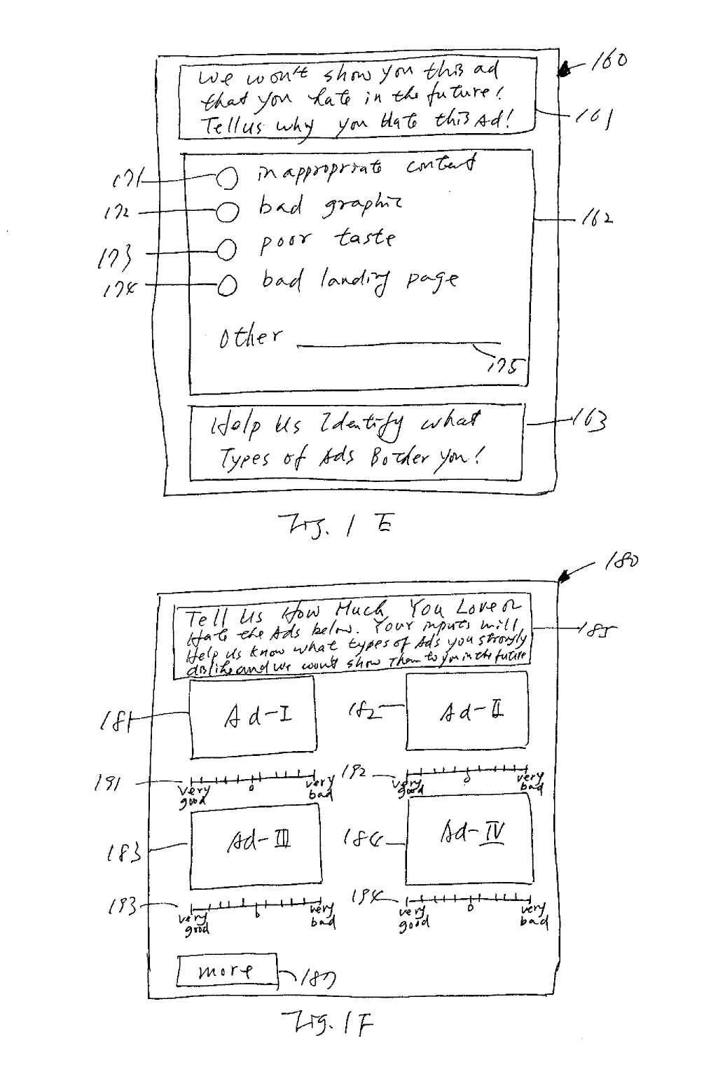

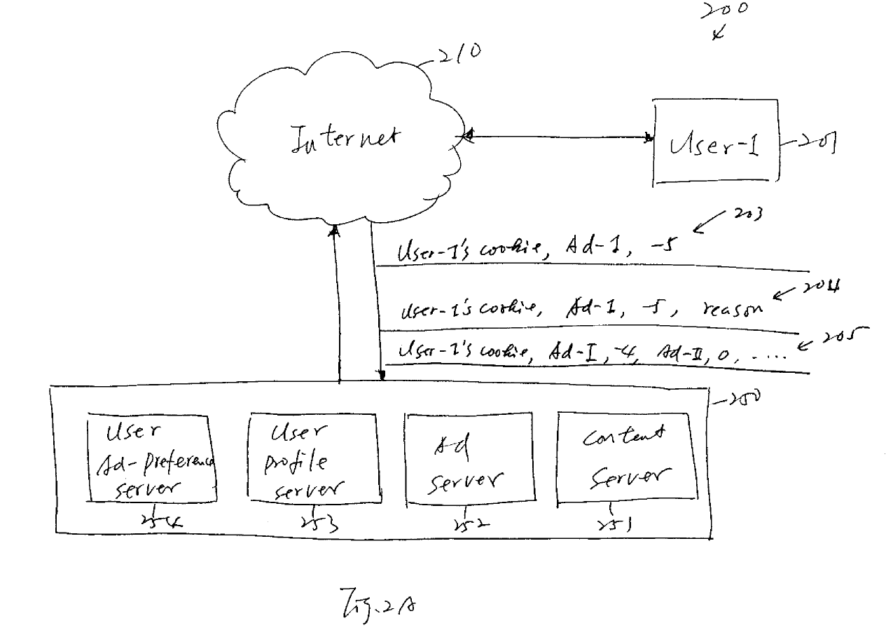

FIG. 1A shows a web browser window (or web page) 100 of a user, User-1, in accordance with one embodiment of the present invention. In the browser window 100 of User-1, there is a content field 101, which contains information that User-1 is viewing. In addition to the content field 101, there is an advertisement-displaying field-1 102 and an advertisement-displaying field-2 103, in window 100. The locations of the two advertisement-displaying field-1 102 and advertisement-displaying field-2 103 of FIG. 1A are merely shown as examples. Advertisements can be displayed at any location of a browser window (or web page). In one embodiment, there is a banner ad 104 displayed in the advertisement-displaying field-1 102, which is near the top of the browser window 100. To the right of the content field 101, there is the other advertisement-displaying field-2 103, which contains an advertisement 105, Ad-1.

When User-1 clicks on Ad-1 (or advertisement 105), an advertisement (or ad) browser window (or web page) 110 appears, in accordance with one embodiment of the present invention. The browser window 110 shows the landing page 111 of Ad-1, as shown in FIG. 1B. The landing page could be any type of landing page, such as a reference landing page, which presents information, or a transactional landing page, which allows a user to complete a transaction. If User-1 strongly dislikes (or hates) the content displayed in browser window 110 of Ad-1, User-1 can click on a “Hate this Ad!” button 150 in browser window 100 of User-1. Button 150 can be named differently, as long as the name conveys a dislike by a user.

User-1 can also click on a button 112 to close the window 110. If User-1 clicks on the “Hate this Ad!” button 150, the system of the web site that displays such an ad, Ad-1, to User-1 can collect this information and can be configured not to display this ad to User-1 again, in accordance with one embodiment of the present invention. In another embodiment, the system of the web site that displays Ad-1 to User-1 can close the browser window 110 of Ad-1 immediately after User-1 clicks on the “Hate this Ad!” button 150. In yet another embodiment, the system of the web site that displays Ad-1 to User-1 can place a different ad in the browser window 110 to replace Ad-1, as shown in FIG. 1C. In yet another embodiment, the system can close browser window 110, open a new browser window 110′, and put a different ad, Ad-2, in the new browser window 110′, as shown in FIG. 1D. In one embodiment, the replacement ad, Ad-2, is related to the subject of Ad-1 as listed in the description of Ad-1 of advertisement 105. In one embodiment, the replacement ad, Ad-2, is an ad that the system knows to be non-offensive to most of the people.

In addition to closing Ad-1 and/or replacing Ad-1 with an alternative ad, Ad-1, a browser window 160 can appear, in accordance with one embodiment of the present invention, as shown in FIG. 1E. The browser window 160 includes a description field 161, which contains a description of “We won't show you this ad that you hate in the future! Tell us why you Hate this Ad!” Under the description field 161, there is selection field 162, which includes multiple choices, such as choice-buttons 171, 172, 173, and 174, following with description of why User-1 hates the ad and a field 175, following the word “Other,” for User-1 to enter reasons why he/she hates the ad by typing in words. The multiple choices lists the possible reasons that User-1 hates the ad. For example, button 171 lists “Inappropriate content,” button 172 lists “bad graphic,” button 173 lists “poor taste,” and button 174 lists “bad landing page.” Other descriptions of reasons why a user, such as User-1, does not like certain ads can be added to the choices or can replace the choices shown in FIG. 1E. The descriptions behind buttons 171, 172, 173, and 174, are merely used as examples. Other descriptions can be used and the number of choices can be more or less

In one embodiment, below the selection field 162, there is an additional information button 163, which contains an exemplary description of “Help Us Identify What Types of Ads Bother you!” If User-1 clicks on button 163, a browser window 180 appears, in accordance with one embodiment of the present invention, as shown in FIG. 1F. In browser window 180, there are a number of fields of test ads, 181, 182, 183, and 184, that include Ad-1, Ad-II, Ad-III, and Ad-1V. In one embodiment, under each test ad, there is a slider, such as slider 191, 192, 193, and 194, with rating from “very good” to “very bad”. User-1 can use the sliders, 191, 192, 193, and 194, to illustrate his/her opinion about the test ads. The four test ads in window 180 are used merely as examples. The number of ads appear in window 180 can be more than four or less than four. Alternatively, under each test ad, there could be buttons for User-1 to choose whether User-1 likes or dislike the ads or fields for User-1 to enter User-1's opinion about the test ads. Alternatively, browser window (or web page) 180 can be configured to let User-1 rank the few ads in window 180, for example choosing from 1, 2, 3, or 4 ranking for each ad in the window 180.

Near the top of browser window 180, there is a description field 185, with description of “Tell Us How Much You Love or Hate the Ads below. You Inputs will Help Us Know What types of Ads you Strongly Dislike and We Won't Show Them to You in the Future!” The incentive for users to provide inputs is seeing less or none of the annoying ads in the future, in the embodiment shown in FIG. 1F. Alternatively, other incentives can be provided to the users. The web site can collect inputs from the users to find out what types of ads really bother people or appeal to people. Inputs from users, such as from User-1, can be collected in a system with databases storing the likes and dislikes of advertisements of the users.

In one embodiment, these inputs from the users can be analyzed by a system to identify trends of users' preference and common traits in ads that bothers certain groups of users. In one embodiment, there is a “more” button 187 near the bottom of window 180. User-1 can push the “more” button 187 to get additional windows (or pages) with ads, which are similar to window 180, to provide inputs on ads. Alternative, User-1 can push a “Love this Ad!” button 155 in browser window 100 to indicate that he/she really love the ad that is displayed in front of him/her. After User-1 presses the “Love this Ad!” button, browser windows similar to windows 160 and 180 can appear to gather more insight into why User-1 love (or like) the ad.

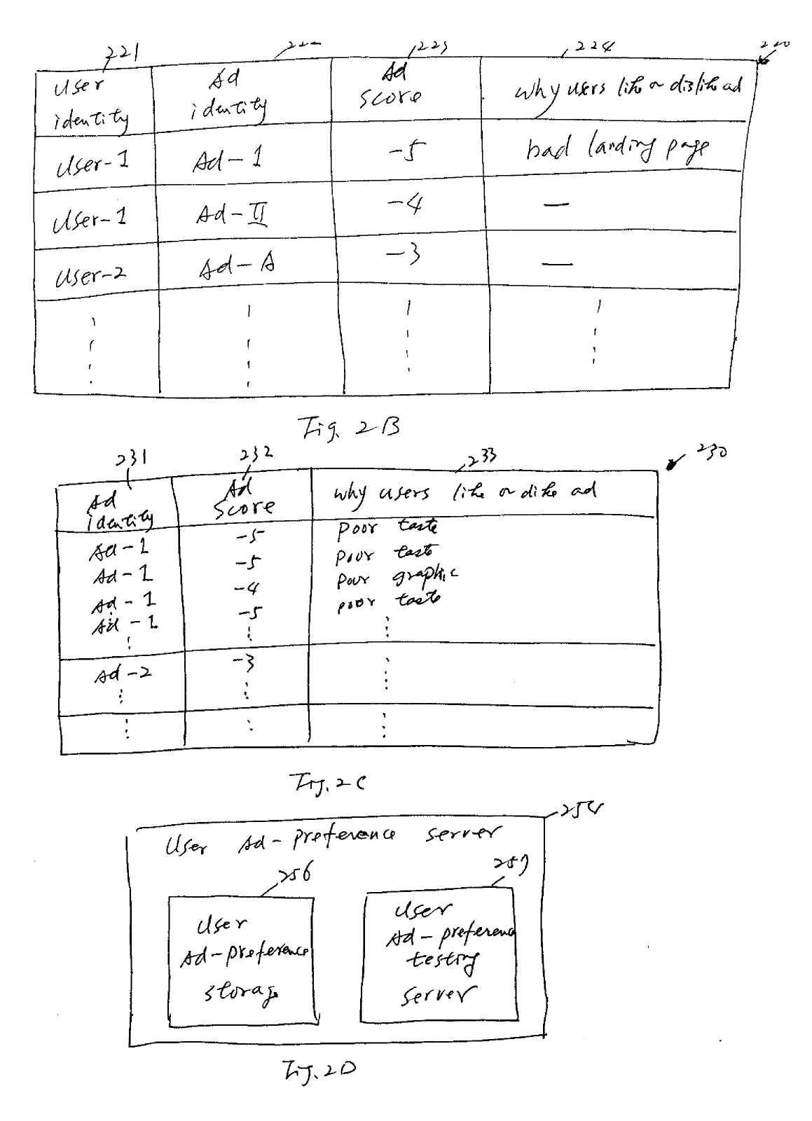

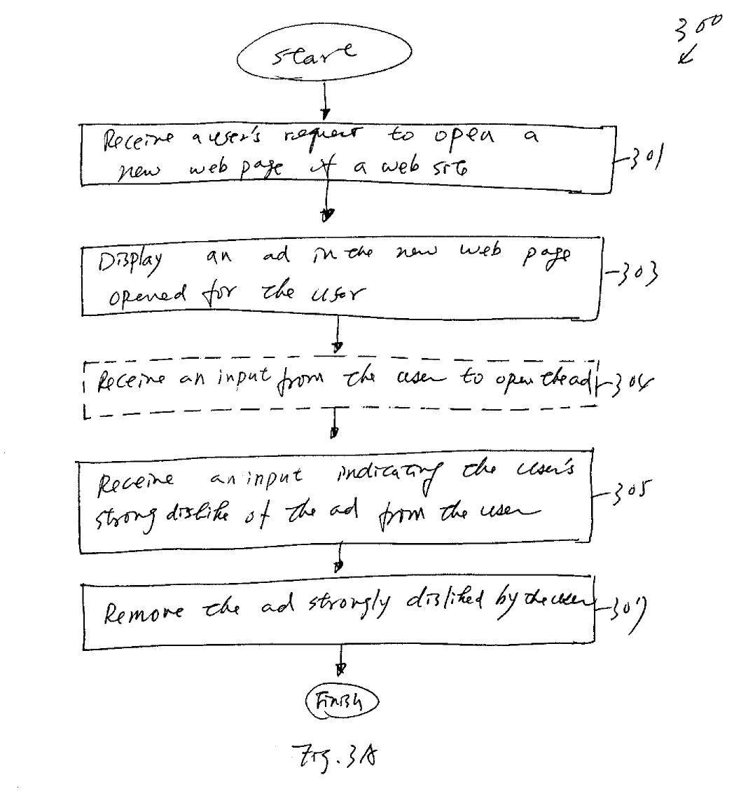

FIG. 2A shows a system 200 for collecting information on ads disliked by users, in accordance with one embodiment of the present invention. In system 200, User-1 uses a system 201 of User-1 to access a system 250 of a web site through Internet 210. The system 250 of the web site has a content server 251, which provides content, such as content shown in content field 101 of FIG. 1A, of web pages for users, such as User-1. The system 250 of the web site also has an Ad server (or advertisement server) 252, which provides ads, such as the banner ad, and/or Ad-1 of FIG. 1A, displayed in the web pages, such as page 100 of FIG. 1A. The information stored in the Ad server 252 may include, but not limited to, links to ads, complete advertisements (such as videos), and descriptions of ads, etc. Further, system 250 has a user profile server 253, which stores user profile information collected by the web site. The user profile information stored in server 253 may include, by not limited to, cookies, email addresses, geographical locations, gender, age, and clicking histories of users, etc.

In addition, system 250 has a user ad-preference server 254, which stores information regarding users' ad preference. For example, the information stored in server 254 includes identities of users, advertisements viewed by users, the scores that represent (or reflect) how much the users like or dislike the corresponding ads. In one embodiment, the information also includes the reason why the users like or dislike the ads.

FIG. 2B shows an example of a table 220 stored in the user ad-preference server 254. Table 220 include a column of user identity 221, a column of ad identity 222, a column of score 223, and a column of “why” 224, which states the reason why the users like or dislike a certain ad. The information collected in FIG. 2B is collected when users, such as User-1, presses “Hate this Ad!” button 150 and makes selections in browser windows 160 and 180 (optional). Such information can also be collected when User-1 pushes “Love this Ad!” button 155 and make selections in browser windows similar to 160 and 180, which are tailored to address why User-1 loves the ad.

The user identity information in user identity column 221 can be collected by cookies of users or by other means. The scores in the score column 223 are used to indicate how much the users like or dislike the ads. For example, a “−5” to “+5” score can be used to rank how much the user likes or dislikes an ad. “−5” can be used to indicate that the user strongly dislikes (or hates) the ad and “+5” can be used to indicate the user strongly likes the ad. Other values or symbols can also be used to represent the scores. When User-1 presses the “Hate this Ad!” button 250 after viewing Ad-1, Ad-1 is given a “−5” score by User-1. In one embodiment, User-1's cookie, the identity of the ad “Ad-1”, and a “−5” score of information stream 203, are sent to the system 250 of the web site, as shown in FIG. 2A. The information is stored in the user ad-preference server 254 in a table 220 of FIG. 2B. After User-1 presses pushes button 163 to open the browser window 180, User-1 selects “bad landing page” 174 as the reason he/she strongly dislike the page. When this occurs, User-1's cookie, the identity of the ad (Ad-1), the score of the ad (−5), and the reason why User-1 hates the ad (bad landing page) of information stream 204 are also sent to the user ad-preference server 254, as shown in FIG. 2S. The information is stored in table 220 of FIG. 2B. When User-1 ranks and rates the ads, such as Ad-1, Ad-II, Ad-III, and Ad-1V, in browser window 180, User-1 cookie, identities of ads and their corresponding scores of information stream 205 are sent to the user ad-preference server 254, as shown in FIG. 2A. In one embodiment, the user ad-preference server 254 can use the user cookies stored in the user profile server 253 to get the identities of users in the information streams, such as 203, 204, 205.

Administrators for the user ad-preference server 254 can analyze data in the user ad-preference server 254, such as data in Table 220, to gain insight into what ads offends or irritate users. For example, when an ad is newly launched, if the first 5 out of 10 users who see the ad press the “Hate this Ad!” button, the system administrator of ads can set up the ad system that temporarily suspends the questionable ad and to further examine the ad before deciding to release the ad again or to suspend the ad permanently. This prevents a bad ad from being viewed by many more users and to annoy many users. The web site can gain by protecting its own reputation since additional many users are prevented from being annoyed The first 5 out of 10 numbers used above are merely used as an example. Other numbers or thresholds can also be used.

As mentioned above, administrators for the user ad-preference server 254 can analyze the Table 220 to gain insight into what ads offends or irritate users. Data in FIG. 2B can be analyzed directly or can be rearranged into a different table, such as table 230, which include an ad identity column 231, a score column 232, and a “why” column 233, which contains information of why the ads are liked or disliked. In Table 230 of FIG. 2C, scores and “why” users like or dislike certain ads are grouped by ads. For example, Ad-1 receives scores of −5, −5, −4, −5, . . . etc., and some scores are with “why” users like or dislike them. The system administrator can gain insight into why users do not like Ad-1 and seek ways to improve quality of ads with advertisers. For example, advertisers with poor ads can improve their ads, be charged with higher prices for their poor ads, or be disqualified by the web site.

FIG. 2D shows an embodiment of the user ad-preference server 254. In the user ad-preference server 254, there is a user ad-preference storage 256, which stores information related users' ad preference, such as table 220 of FIG. 2B, and table 230 of FIG. 2C. In one embodiment, the user ad-preference server 254 also include a user ad-preference testing server 257, which provide content to generate browser windows (or web pages) similar to windows 160 and 180 to test (or to collect) users' ad preference. In one embodiment, the user ad-preference testing server 257 works in conjunction with the ad server 252 to generate the test pages, such as pages similar to window 180. The ads, is such as Ad-1, Ad-II, Ad-II, and Ad-IV, in the testing pages, such as the one shown in window 180, are provided by the ad server 252. Alternatively, the ads in the question pages, such as window 180, are stored in the user ad-preference testing server 257.

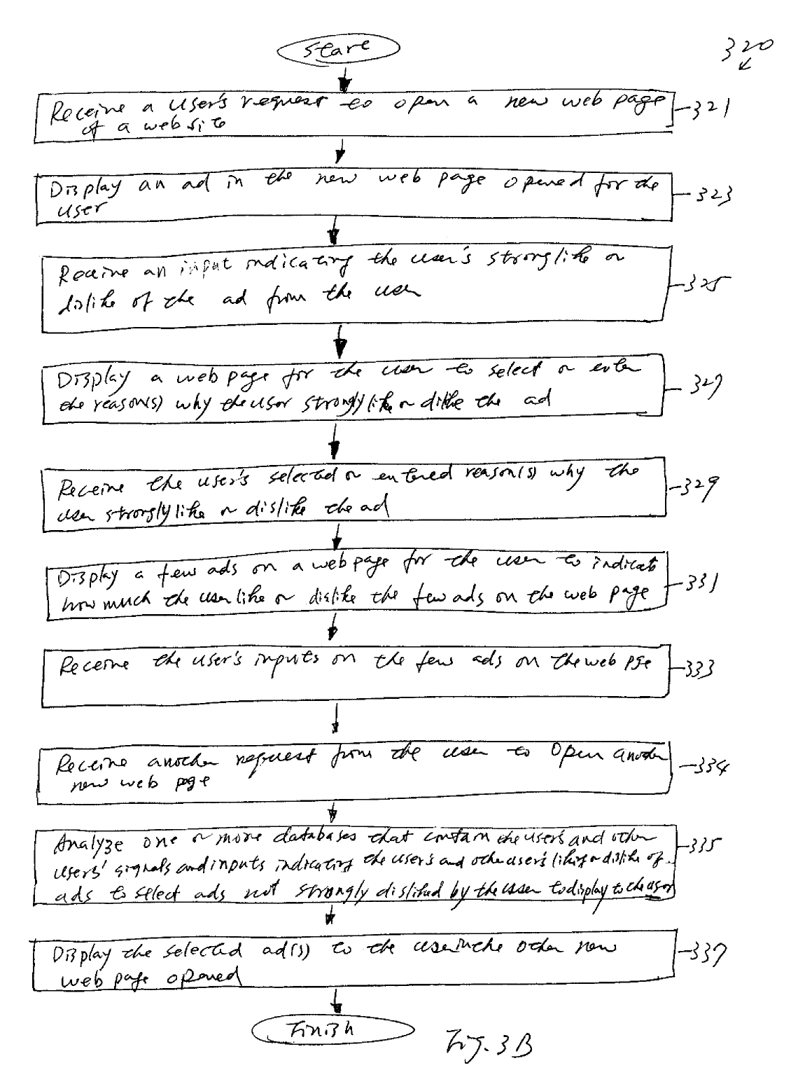

FIG. 3A shows a process flow 300 of removing an ad strongly disliked by a user, in accordance with one embodiment of the present invention. At operation 301, a user's request to open a new web page (or new browser window) of a web site is received. The web site could be any web site that provides content, such as information and/or applications, to users. Information provided by the web site can be anything that is needed by users. For example, articles, comments, news, video, photos, etc. Applications provided by the web site can be any web-based tools, such as e-commerce transaction tools to facilitate purchasing and online games, etc.

When the web site receives the user's request to open a new web page, the web site prepares a web page with content and ads. At operation 303, an ad is displayed in the new web page that is opened for the user based on the user's request. In one embodiment, the ad needs to be clicked by the user to open by the landing page of the ad. In another embodiment, the ad is displayed in the web page and does not require the user to take any action. In the case that the user needs to open the ad, the user send an input (or a signal) to the system, such as by clicking on the ad, to indicate that the user wants to see contents of the ad at optional operation 304. Once the user clicks on the ad, a landing page of the ad is displayed to the user.

After the user views the ad, in one embodiment, the user feels a strong dislike for the ad displayed to him/her. As described above, the user presses a button, such as the “Hate this Ad!” button 150 on the web page. When the user presses the button, the system of the web site receives an input indicating the user's strong dislike of the ad from the user at operation 305. When the system receives such an input, the system removes the ad strongly disliked by the user at operation 307. The ad can be removed by closing the window with the landing page of operation 304 and/or can be closed by removing the ad displayed in the new web page requested by the user, which includes the ad. Alternatively, a new ad can be used to replace the ad strongly disliked by the user.

FIG. 3B shows FIG. 3A shows a process flow 320 of recording opinions on ads of users, in accordance with one embodiment of the present invention. At operation 321, a user's request to open a new web page (or new browser window) of a web site is received. The web site could be any web site that provides content, such as information and/or applications, to users. When the web site receives the user's request to open a new web page, the web site prepares a web page with content and ads. At operation 323, an ad is displayed in the new web page that is opened for the user based on the user's request. After the user views the ad, the user feels a strong dislike or like for the ad displayed to him/her. As described above, the user presses a button, such as the “Hate this Ad!” button 150, or the “Love this Ad!” button 155 on the web page. When the user presses the button, the system of the web site receives an input indicating the user's strong like or dislike of the ad displayed to the user at operation 325. When the system receives such an input, the system displays a web page for the user to select or enter the reason(s) why the user strongly like or dislike the ad displayed to him/her at operation 327. If the user had indicated that the user strongly dislikes the ad, the web page would allow the user to select or enter the reason(s) why the user strongly dislikes the ad. If the user had indicated that the user strongly likes the ad, the web page would allow the user to select or enter the reason(s) why the user strongly likes the ad.

After the user views the web page, the user selects or enters his/her reason(s) at operation 329. In one embodiment, the process flow 320 stops at operation 329. In another embodiment, process flow 320 continues to the next operation. When the process flow 320 continues at next operation 331, the system displays a web page with a few test ads for the users to indicate how much the user like or dislike these few test ads. Other alternatives of indicating the user's preference or opinions of the few ads have been described in the description of FIG. 1F. After the user views the few ads on the web page, the user enter his/her inputs on how much he/she likes or dislikes the few ads. At operation 333, the system receives the inputs from the user on the few ads. In one embodiment, process flow 320 stops at operation 333. In one embodiment, process flow continues to next operation. At next operation 334, the system receives another request from the user to open another new web page of the web site. After the system receives the user's request, the system analyzes one or more databases that contain the inputs from the user and from other users, indicating the user's and other users' strong likes or dislikes of ads displayed, including reasons why, at operation 335, to select ads to display to the user. The analysis would lead to not selecting ads that are disliked by the user and select ads that are likely acceptable by the user. At operation 337, the selected at least one ads is displayed to the user.

The present invention fills the need of avoiding displaying advertisements that are strongly disliked by the users. Displaying advertisements that are strongly disliked (or offend) users, web sites stand the chance of driving users away or losing users. By allowing users to identify advertisements that offend or annoy (or strongly disliked by) them, web sites can configure the systems so that offensive or annoying advertisements are not displayed to the offended or annoyed users. In addition, when a user is seriously turned off by an advertisement to indicate his/her strong dislike for the advertisement (ad), the user is likely to disclose the reason why he/she does not like the ad, and could be willing to provide further information on what types of ads that are liked or disliked by the user. Web sites can collect the inputs on their preference of advertisements of users to target future ads. Knowing users' (or customers') preference in ads allow web sites to more successfully select ads to display to users to keep users happy and keep coming back. Knowing users' strong dislikes of ads can also allow web sites to not send the ads strongly disliked by users to them and avoids angering or driving away users. Alternatively, the methods and systems described above can be used to collect inputs users regarding ads that they like.

With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of removing an advertisement disliked by a user from a web page of a web site, comprising:
receiving a request from the user to open the web page of the web site;
displaying an advertisement in the web page opened for the user based on the request;
receiving an input from the user indicating a dislike of the advertisement that was displayed; and
removing the advertisement that was displayed and disliked by the user.

2. The method of claim 1, further comprising:
receiving an input from the user to open the advertisement, wherein the advertisement in the web page is displayed after receiving the input form the user to open the advertisement.

3. The method of claim 2, wherein displaying the advertisement leads to a landing page for the advertisement.

4. The method of claim 1, wherein the input is provided by a button click to indicate the dislike of the advertisement.

5. The method of claim 1, wherein removing the advertisement is accomplished by closing the advertisement.

6. The method of claim 1, wherein removing the advertisement is accomplished by replacing the advertisement that the user dislikes with another advertisement.

7. The method of claim 1, wherein after receiving the input from the user indicating the dislike of the advertisement, the advertisement that was disliked by the user will not be displayed to the user in the future visits by the user.

8. A method of recording inputs of users on advertisements to prevent displaying advertisements that are known to be disliked by the users, comprising:
displaying an advertisement in a web page opened for the user based on a request from the user;
receiving an input from the user indicating a preference of the advertisement displayed, wherein the input from the user is saved in at least one database;
displaying a plurality of advertisements in another web page for the user to indicate preferences of the user on the plurality of advertisements displayed in the other web page to gain insight of preferences of advertisements of the user;
receiving inputs from the user indicating the preference of the user on the plurality of advertisements displayed on the other web page, wherein the inputs are saved in the at least one database;
analyzing the at least one database containing the inputs from the user to select advertisements to display to the user, wherein the inputs indicate the preferences of advertisements of the user, and the analysis of the at least one database prevents displaying advertisements that are known to be disliked by the user; and
displaying the advertisements that are selected to the user.

9. The method of claim 8, further comprising:
receiving a request from the user to open the web page of the web site before displaying the advertisement in the web page; and
receiving another request from the user to open the other web page before displaying the plurality of advertisements in the other web page.

10. The method of claim 8, further comprising:
displaying a separate web page for the user to select or to enter the reason behind the user's preference of the advertisement displayed after receiving the input from the user indicating the preference of the advertisement displayed; and
receiving the reason selected or entered by the user.

11. The method of claim 8, further comprising:
receiving an input from the user to open the advertisement, wherein the advertisement in the web page is displayed after receiving the input form the user to open the advertisement; and
displaying the advertisement in a separate web page after receiving the input from the user to open the advertisement.

12. The method of claim 11, wherein the displaying the advertisement in the separate web page results in a displaying a landing page for the advertisement.

13. A system for recording inputs of users on advertisements to prevent displaying advertisements that are disliked by the users, comprising:
an advertisement server storing advertisements to be displayed in web pages;
a user profile server storing information of the users; and
an advertisement-preference server storing information regarding the user preference for advertisements, wherein the information includes user identifications with advertisements that are disliked by the corresponding user identifications, wherein the advertisement-preference server is integrated with the user profile server and the advertisement server to prevent displaying advertisements that are disliked by the users.

14. The system of claim 13, wherein the advertisement-preference server stores identities of users, identities of advertisements, and scores reflecting the user preference of the corresponding advertisements.

15. The system of claim 14, wherein the advertisement-preference server further stores reasons behind the user preference of the corresponding advertisements.

16. The system of claim 14, wherein the reasons behind the user preference of the corresponding advertisements are used to improve quality of advertisements.

17. Computer readable media including program instructions for recording inputs of users on advertisements to prevent displaying advertisements that are known to be disliked by the users, comprising:
program instructions for displaying an advertisement in a web page opened for the user based on a request from the user;
program instructions for receiving an input from the user indicating a preference of the advertisement displayed, wherein the input from the user is saved in at least one database;
program instructions for displaying a plurality of advertisements in another web page for the user to indicate preferences of the user on the plurality of advertisements displayed in the other web page to gain insight of preferences of advertisements of the user;
program instructions for receiving inputs from the user indicating the preference of the user on the plurality of advertisements displayed on the other web page, wherein the inputs are saved in the at least one database;
program instructions for analyzing the at least one database containing the inputs from the user, wherein the inputs indicate the preferences of advertisements of the user, to select advertisements to display to the user, wherein the analysis of the at least one database prevents displaying advertisements that are known to be disliked by the user; and
program instructions for displaying the advertisements that are selected to the user.

18. The computer readable media of claim 17, further comprising:
program instructions for receiving a request from the user to open the web page of the web site before displaying the advertisement in the web page; and
program instructions for receiving another request from the user to open the other web page before displaying the plurality of advertisements in the other web page.

19. The computer readable media of claim 17, further comprising:
program instructions for displaying a separate web page for the user to select or to enter the reason behind the user's preference of the advertisement displayed after receiving the input from the user indicating the preference of the advertisement displayed; and
program instructions for receiving the reason selected or entered by the user.

20. The computer readable media of claim 17, further comprising:
program instructions for receiving an input from the user to open the advertisement, wherein the advertisement in the web page is displayed after receiving the input form the user to open the advertisement; and
program instructions for displaying the advertisement in a separate web page after receiving the input from the user to open the advertisement.
